(19) United States
(12) Patent Application Publication
(10) Pub. No.: US 2009/0019258 A1
(43) Pub. Date: Jan. 15, 2009

(54) FAULT TOLERANT SELF-OPTIMIZING MULTI-PROCESSOR SYSTEM AND METHOD THEREOF

(76) Inventor: Justin Y. Shi, Wayne, PA (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 12/168,214

(22) Filed: Jul. 7, 2008

Related U.S. Application Data
(60) Provisional application No. 60/948,513, filed on Jul. 9, 2007.

(51) Int. Cl. G06F 15/76; G06F 9/30

(52) U.S. Cl. 712/29; 712/E09.016

(57) ABSTRACT

A fault-tolerant self-optimizing multi-processor system is disclosed that includes a plurality of redundant network switching units and a plurality of processors electrically coupled to the network switching units. Each processor comprises a local memory, local storage, multiple network interfaces and a routing agent (RA). The RAs form a unidirectional virtual ring (UVR) network using the redundant network switching units. The UVR network may coordinate all of the processors for data matching, failure detection/recovery and system management functions. Once data is matched via the UVR network, application programs communicate directly via the network switching units, thus fully exploiting the hardware redundancy. Each of the RAs may implement a tuple space daemon responsible for data matching and delivery, forwarding unsatisfied data requests to a downstream processor or dropping expired tuples from UVR circulation. The RAs provide overall system fault tolerance and are responsible for delivering data sources to the matching processors.

### CROSS REFERENCE TO RELATED APPLICATION

This application claims the benefit of U.S. Provisional Patent Application No. 60/948,513 filed Jul. 9, 2007, which is incorporated by reference as if fully set forth.

### FIELD OF INVENTION

The present invention is generally related to reliable high performance computer systems. More particularly, the present invention is related to a stateless parallel processing machine (SPPM) architecture having a plurality of processors, (i.e., computing nodes), connected to a plurality of redundant network switches and routers, whereby each processor includes local memory, local storage, multiple network interfaces and a routing agent (RA), and the RAs form a unidirectional virtual ring (UVR) that is responsible for coordinating the processors for data matching, failure detection/recovery and system management functions.

### BACKGROUND

The awe-inspiring speed of high performance computer systems has fostered high hopes for high-end mission critical applications. These hopes have also spread to using remotely connected processors, (i.e., grid computing). A careful examination, however, reveals fundamental difficulties. The first is application availability: the ability of an application to survive one or more physical processing/communication component failures. Currently, the failure of a single physical component typically halts the entire application in all existing multiprocessor systems. Fault tolerant applications have been proven cost prohibitive to build and impractical to deploy and maintain.

The nature of online information processing demands continuous scalable performance and service availability from providers. Existing architecture's replication subsystem uses either synchronous or asynchronous methods that impose debilitating limitations to the applications. Although required, achieving high performance and high availability within the architecture has been considered impossible.

Next-generation architecture for very large scale information processing applications may be built that can deliver high performance and high availability at the same time. However, the problem of building high performance architecture with built-in high availability and zero information loss is technically very difficult. Many researchers believe this is an open problem that one could only expect to achieve high performance or high availability, but not both.

Recent developments in stateless parallel processing (SPP) have shown that it is indeed possible to achieve both high performance and high availability at the same time if we apply SPP principles at all aspects of the architecture design. The most recent reference is the inquiry from the Department of Homeland Security (DHS) concerning the shortcomings of existing enterprise service bus (ESB) availability measures. Preliminary studies have shown that it is theoretically possible to use the SPP principle to build a lossless high performance ESB architecture with a scalable transaction processing layer using commodity components.

The opportunity is vast. All online applications today are mission critical to certain extend. All can benefit from the proposed new architecture. Almost all recent technology advancements focus on the ease of application developments using the wired or wireless networks. The current architecture weaknesses are well known and under-addressed.

Timing models quantify the best-case deliverable performance of a program, parallel or serial. Unlike qualitative models, such as Amdhal's Law, timing models can predict the best-case performance cap, pin-point performance bottlenecks and guide optimal granularity search.

The key concept is to introduce application dependent hardware processing capabilities. Most researchers believe these capabilities fluctuate too much and are not useable for modeling purposes. They actually exhibit well-understood behaviors. For example, FIG. 1 shows (w), the application dependent million operations per second (MOPS) for a matrix multiplication program. There is a clear cache, memory, swapping and die (CMSD) performance envelope. In fact, all applications show similar performance envelopes if you plot their MOPS curves, (worst-case complexity divided by measured elapsed times).

The timing model for a parallel matrix application is defined as:

$${T}_{par} = \frac{{N}^{3}}{P ω} + \frac{δ {N}^{2} ( P + 1 )}{μ} ; \qquad Equation ( 1 )$$

where N=problem size, and P=number of processors and μ is the application dependent network speed, (e.g., bytes per second), and δ is matrix cell size in bytes. This model indicates a row or column stripping partitioning strategy.

Together with its sequential model and targeted program instrumentation via serial codes, (to obtain the boundaries of a CMSD envelope), the best cost-effective parallel performance may be easily derived for any given processing environments. The most important revelation is probably that synchronization costs far more than communication since a single slow processor typically hangs the entire application. Through extensive computational experiments, it can be shown that the performance loss due to indirect communication overhead (induced by implicit data parallel processing) can indeed be compensated in reduced overall system synchronization overhead by finding the optimal processing grain size (load balancing). For larger scale complex applications, computing time varies substantially amongst all processors. Only the optimally chosen processing granularity can claim the best performance by forcing all processors to complete at exactly the same time.

Many projects, encouraged by the high processing rates of parallel computing and practical application needs, push the technology envelope such that their running times have already surpassed the mean time between failure (MTBF) of the multiprocessor systems. High performance computing (HPC) application programmers are routinely responsible for producing “restartable” programs, or risk loosing all of their unsaved work up to the time of the failure.

There are other persistent problems, the most obvious of which is poor programmability. Parallel programming using explicit parallelism controls, such as direct message passing and shared memory protocols, have been proven difficult and error prone. Today, automatic parallel code generation from sequential code is elusive as it was twenty years ago.

Direct message passing and shared memory programming models require the application programmers to create and control application parallelisms directly in their code resulting in three detrimental effects. The first detrimental effect is difficulty in producing cost efficient performance (load balanced). These parallel programs are rigid in structure after being compiled. Therefore, high performance relies purely on meticulously crafted structures based on a fixed hardware setting. Any change in the processing environment or the data inputs will throw the entire application out of balance. The second detrimental effect is difficulty in application fault tolerance. Explicit parallelism by the application pays no attention in limiting its processing states. Processing states are spread to all physical processing and communication components. The failure of a single physical component can shutdown the application. The third detrimental effect is difficulty in programming. It takes years to learn to become a good serial programmer. Explicit parallel programming requires domain knowledge, parallel processing principles, (such as cache coherence and race conditions), hardware topology and all skills required for a good serial programmer. It is a daunting task. Since the vast majority high performance applications come from domain experts, the economic model of training parallel application programmers simply does not scale.

It is evident that explicit parallelism can deliver high performance for meticulously crafted special purpose parallel applications. However, difficulty of programming makes them inadequate when building on fast changing information technology (IT) infrastructures. The rigid parallel application structure makes it impractical to exploit optimal processing granularity, and is incapable of handling dynamic environments, thus failing fault tolerance and load balancing requirements. A reliable high performance computer system that overcomes the detrimental effects and challenges described above would be highly desirable.

### SUMMARY

The present invention includes a fault-tolerant self-optimizing multi-processor system that includes a plurality of redundant network switching units and a plurality of processors electrically coupled to the network switching units. Each processor comprises local memory, local storage, multiple network interfaces and a routing agent (RA). The RAs of the processors form a UVR network.

The UVR network may coordinate all of the processors for data matching, failure detection/recovery and system management functions. Each of the RAs may implement a tuple space daemon responsible for data matching and delivery, forwarding unsatisfied data requests to a downstream processor or dropping expired tuples from UVR circulation. Each of the RAs may provide application management such that one or more local processes may be executed, monitored, killed or suspended upon request. Each of the RAs may provide UVR management by monitoring, repairing, reconfiguring, stopping and starting the UVR network. Each of the RAs may provide fault tolerance, wherein the RA runs a self-healing protocol by maintaining a “live downstream processor” contact. The UVR network may facilitate parallel dataflow communications for application data matching. The actual data exchanges are carried out directly point-to-point via the redundant network switching units.

The present invention also includes an SPP system comprising a UVR network, a plurality of processors, wherein each of the processors includes an RA that forms the UVR network, and a redundant physical point-to-point network in communication with the processors, wherein the UVR network is capable of leveraging multiple network interfaces on each processor such that each processor may selectively communicate with any other processors using any available network interface.

The present invention also includes a method of processing data using an SPP system including a plurality of processors. The method comprises selectively connecting a plurality of processors to each other via a redundant point-to-point physical network switching fabric, each of the processors including multiple network interfaces and a RA, and using the RAs and a subset of the switching fabric to form a UVR network, wherein the UVR network coordinates all of the processors for data matching, failure detection/recovery and system management functions. Actual data exchanges are carried out directly and in parallel via the redundant point-to-point switching fabric.

### BRIEF DESCRIPTION OF THE DRAWINGS

A more detailed understanding may be had from the following description, given by way of example in conjunction with the accompanying drawings wherein:

FIG. 1 shows a conventional application dependent performance envelope (MOPS);

FIG. 2 shows a block diagram of a fault-tolerant self-optimizing multi-processor system using SPPM architecture;

FIG. 3 shows the concept of a parallel UVR broadcasting algorithm;

FIG. 4 shows parallel markup language (PML) tags;

FIG. 5 shows the PML marked sequential matrix program; and

FIG. 6 shows performance of PML, SPPM and explicit parallel programs.

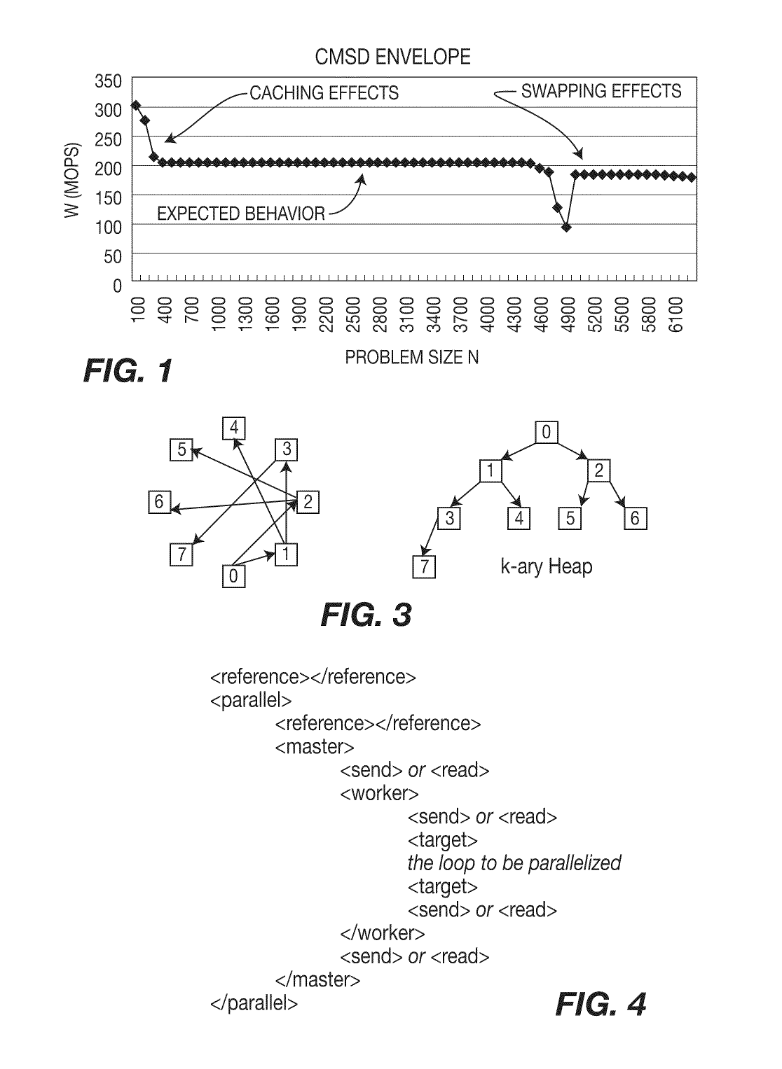

### DETAILED DESCRIPTION

SPP is a multiprocessor design discipline for building multiprocessor architectures and parallel programming models. SPP applies to multiprocessor information processing architecture designs including but not limited to high performance computing clusters, large scale transaction processing clusters and large scale search engine clusters.

SPP is particularly suitable for addressing the programming difficulty issues and delivering high performance and high availability at the same time. PML has been developed to facilitate the automatic data parallel code generation from sequential code and to aid in finding the optimal processing granularity. Timing models are also introduced to aid the discussion of stateless parallel processing machine (SPPM) performance potentials and in identifying the optimal processing grain size. Assuming inter-processor communication is costly, SPP is a simple theory that requires the minimal number, if all possible, of computational and communication state exchanges between all components of a multiprocessor architecture. For high performance, SPP allows maximal possible load distribution potentials due to the least dependencies exposed. For high availability, SPP also makes sense since the smallest number of state exchange makes the minimal replication overheads possible (for fault tolerance). Designs that violate the SPP discipline invariably loose the peak performance potentials, or availability potentials or both.

In a multiprocessor high performance computing cluster, direct network connections between processors should not be allowed, since they represent single point failures and potential performance bottlenecks. Violation of this SPP discipline makes application fault tolerance very expensive. Although meticulous programming has demonstrated high performance for short duration, to date the average performance yield is poor amongst all HPC applications.

Similarly, direct message passing between the processors at the application level also violates the SPP discipline thus results in similar consequences. High density processor developments and recent GPU computing trend can reduce the severity of these problems. The fundamental issues do not change.

This invention discloses that an SPP high performance computing cluster should employs two networks, a redundant physical point-to-point network and a UVR network. The UVR network can leverage multiple network interfaces on each processor and the redundant physical network switches and routers (switching fabric) to accomplish large scale work distribution with scalable performance and high availability at the same time. The redundant physical point-to-point network provides the building blocks for UVR and multiple direct parallel data exchange paths once the processors have identified their data sources.

The central focus of SPPM design is cost effectiveness. Theoretically, only stateless hardware/software components can enjoy the benefits of cost-effective fault tolerance. Historically, fault tolerance means sacrificing performance. SPP provides an exception to this belief. If each calculation is treated as a transaction, there are only two kinds of transactions: a) transactions that cannot be recovered mechanically if lost; and b) transactions that can be recovered mechanically.

The vast majority of HPC calculations are the later. This suggests temporal redundancy as opposed to spatial redundancy, which is much more costly. Temporal redundancy is equivalent to check-point-restart (CPR) used in operating systems. For HPC, temporal redundancy can be easily provided by an enhanced communication layer, which not only helps with fault tolerance, but also facilitates programming ease and load balancing at the same time. Therefore, SPPM promises to gain cost effective high performance by finding the optimal processing granularity after programs are compiled.

A stateless program is defined as a program that computes on repetitive inputs and delivers the results without preserving global states, (often called a “worker”). An SPP application consists of communicating stateless (workers) and statefull (master) programs with the minimal number of exposed states. An SPPM is a multiprocessor architecture consisting of multiple hot-swappable computing and communication components.

The core SPP concept is a higher level communication layer that implements the dataflow implicit parallel processing model. In particular, a tuple space mechanism is used. However, tuple space daemons are implemented to provide the proposed layer on top of networking operating systems. It is this communication layer and its unique implementation that promises to deliver high performance and high availability at the same time without increasing application development complexity.

There are many difficult problems, perhaps the most difficult of which is the deliverable performance of the promised machines. Although the dataflow programming model is naturally stateless, historically, dataflow machines have not been able to deliver competitive performance.

Using SPPM architecture, a simple implementation of a dataflow system can compete effectively with direct message passing systems using the same hardware. In the dataflow system, there are no race conditions and cache coherence issues to consider, processor scheduling is completely automated, parallel codes are automatically generated and fault tolerance is cheap.

SPPM architecture focuses on leveraging existing and future computing and communication devices. A good multiprocessor architecture will allow individual processing and communication components to advance while harnessing the best of their capabilities. For cost-effective performance, SPPM architecture leans heavily on the dataflow parallel processing model for automatic formation of single instructions multiple data (SIMD), multiple instructions multiple data (MIMD) and pipeline processor clusters at runtime.

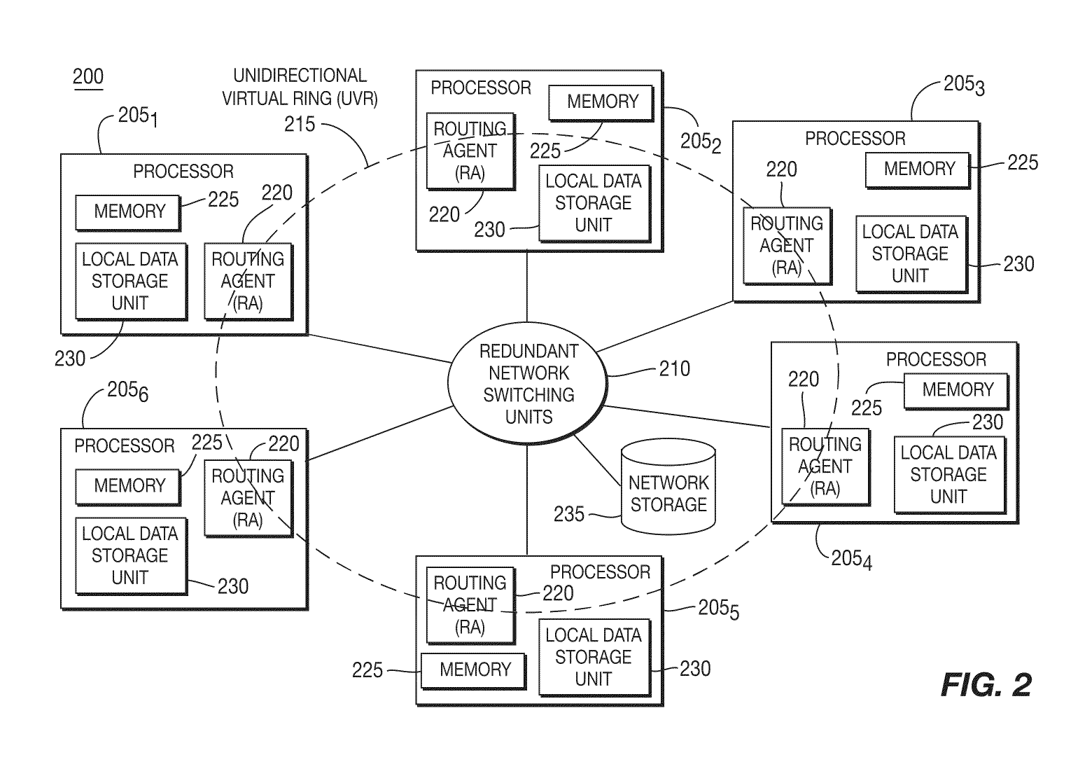

FIG. 2 shows the conceptual diagram of an SPPM architecture 200. The SPPM architecture 200 includes a plurality of processors 205₁, 205₂, 205₃, 205₄, 205₅ and 205₆ and a plurality of redundant network switching units 210. Each processor 205 is a fully configured computer with routing agent (RA) 220, a memory 225 and a local data storage unit 230 and multiple network interfaces. A network storage 235 holds the application programs and data. Each processor 205 may be a uniprocessor or a multi-core processor, with or without hyper threading support. Each processor 205 is connected to the rest of the processors 205 via a plurality of redundant network switching units 210, (i.e., a switching fabric), which provides multiple physical paths to the other processors 205.

The RAs 220 of the processors 205 form a UVR network 215. The UVR network 215 is responsible for coordinating all of the processors 205 for data matching, failure detection/recovery and system management functions.

Each of the RAs 220 provide fault tolerance. Each RA 220 runs a self-healing protocol by maintaining the “live downstream processor” contact. This includes automatic initiation of failure recovery routine if the current downstream processor becomes inaccessible. This task not only takes care of detection and recovery of processor and networking device failures, but also affords non-stop processor repair and dynamic system expansion and contraction.

Each of the RAs 220 also provide data management. Each RA 220 implements a local data store, (tuple space daemon), responsible for data matching and delivery, forwarding unsatisfied data requests to the downstream processor or dropping expired tuples from UVR circulation.

The RAs 220 also provide application management such that one or more local processes may be executed, monitored, killed or suspended upon request. The RAs also provide UVR management by monitoring, repairing, reconfiguring, stopping and starting the UVR 215.

A parallel application may reside on all of the processors 205 or on the shared stable storage. It starts with a “launch application X” tuple from an initiating processor 205. The host RA 220 interacts with others following the unique order in a UVR membership list and automatically propagates the local unsatisfied data requests onto other processors 205 on the UVR 215, (linearly or in LogₖP fashion). A processor 205 holding a matching tuple sends it directly to the requesting processor.

The SPP application completes when all of its processes terminate. The core device in FIG. 2 is the UVR 215. The UVR 215 facilitates parallel dataflow (for tuple matching) communication. Unlike past dataflow machines, SPPM architecture is scalable since a token (tuple) matching function is fully distributed to all participating processors 205. Actual data transmissions are carried out directly from the data holders to the requesters via multiple redundant network switches.

One salient feature of UVR is its embedded parallel communication potential: UVR broadcast protocol employs an automatically adjusted LogₖP (ring hopping) algorithm, where P is the number of processing nodes and k is the degree of parallel communication on UVR. The ring hopping algorithm (RHA) ensures that the worst-case network diameter is no more than LogₖP.

FIG. 3 shows the concept of a parallel UVR broadcasting algorithm using a binary heap hopping pattern (k=2). The RAs 220 may also choose to use multiple network paths to implement parallel UVR functions for very large scale clusters. For a million-node cluster and k=2, it will take at most 20 hops to complete one broadcast saturation cycle (any to any). In comparison, hypercube, and 3-D torus topologies are much less scalable due to their rigid topology and bandwidth limits. The k value can be adjusted to accommodate the limitations of the switching fabric.

Network collisions can be mitigated by adding high speed switches and network interfaces per node. Considering the existing processor bus speeds, each node (single or multi-core) can easily support many network interfaces.

Once running, the SPPM architecture 200 allows automatic exploitation of SIMD, MIMD and pipeline parallelisms at runtime. The processing granule sizes can be tuned externally after programs are compiled, before launching the application or self-tuned while the application is running.

Processor and network failures are first recovered by autonomous RAs 220 to ensure a consistent UVR is intact. The stateless parallel programs (workers) are automatically recovered by re-issuing shadow tuples by respective RAs 220. Master failure will be recovered by a system-level CPR method, leveraging the shared network storage 235. The application will slow down when failures occur, but it will not stop until the last processor crashes. Note that tuple shadowing has no performance impact on the running application until a failure occurs, (cheap fault tolerance).

SPPM architecture also allows dynamic expansion, contraction and even overlaying of processor pools. This lends it conveniently for building special purpose or commercial data processing centers permitting full utilization of any available resources. Highly secure special purpose SPPMs can also be built by exploiting publicly available resources.

Stateless parallel programming does not require the application programmer to manage parallel processes. Unlike the past dataflow machines that a special dataflow language had to be designed, using SPPM, we ask the application programmer to partition his/her application to expose parallelism in a coarse-to-fine progression. It is commonly accepted that a coarse-grain partition requires less communication than finer grain partitions. Timing models are simple and effective guides in finding the optimal granularity. Reversing the direction of parallelism exploration leads to explosively many alternatives that often lead to eventual failure.

This gradual coarse-to-fine parallelism exploitation can also be automated by marking up the sequential program. A parallel markup language (PML) has been developed to show the effectiveness of SPPM. PML is a XML-like language that contains seven tags, as shown in FIG. 4. The “reference” tag marks program segments for direct source-to-source copy in their respective positions. The “master” tag marks the range of the parallel master. The “send” or “read” tags define the master-worker interface based on their data exchange formats. The “worker” tag marks the compute intense segment of the program that is to be parallelized. The “target” tag defines the actual partitioning strategy based on loop subscripts, such as tiling (2D), striping (1D) or wave-front (2D). The general practice is to place “target” tags in an outer loop first and then gradually drive into deeper loop(s) if the timing model indicates that there are unexploited communication capacities.

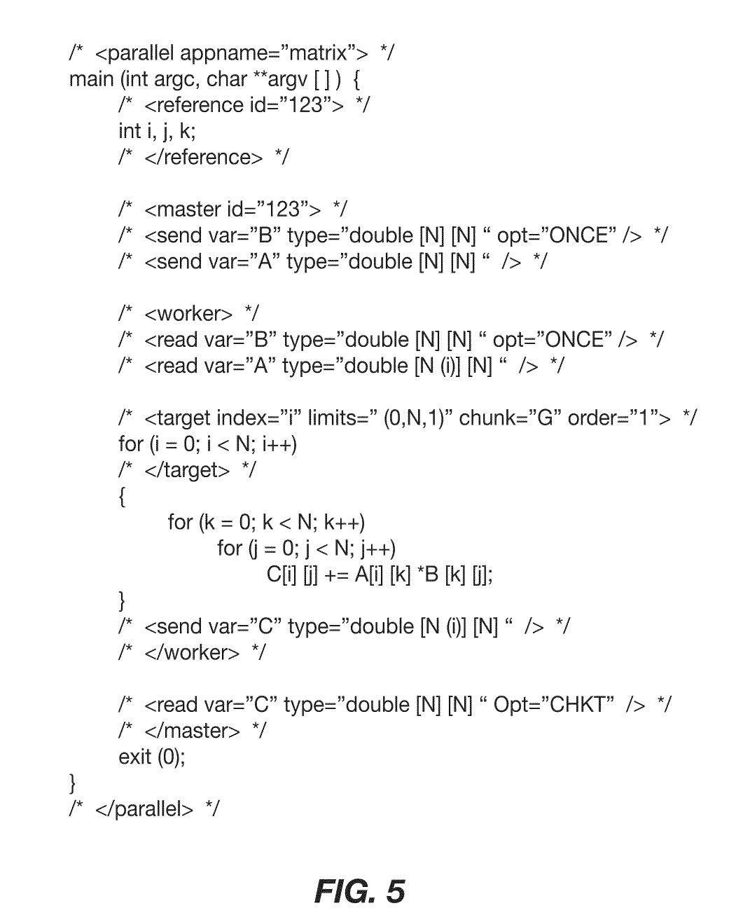

FIG. 5 shows the PML marked sequential matrix program.

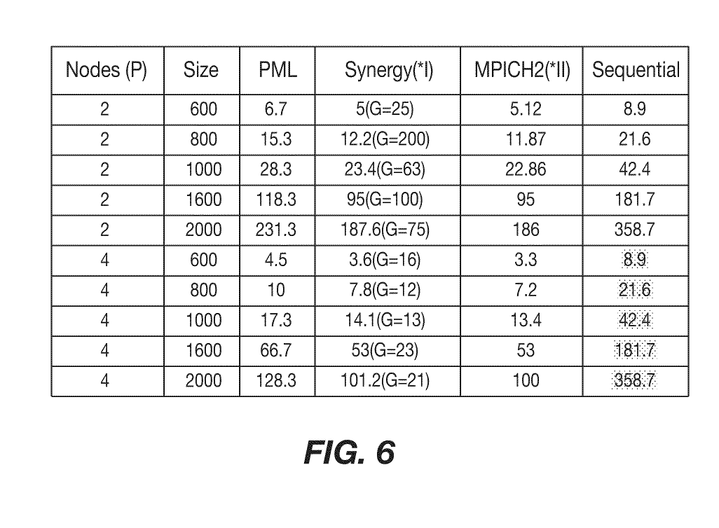

FIG. 6 shows the performance comparisons between PML generated code, (parallel matrix multiplication), manually crafted stateless parallel programs and programs using direct message passing protocol (MPICH). To demonstrate the feasibility of SPPM and PML, preliminary performance data is presented comparing automatically generated SPP code against hand-crafted SPPM and MPICH codes using a prototype SPPM implementation on a Sun Blade500 cluster. The manually crafted stateless programs were tested using Synergy v3.0 along with MPICH2-0.971, and compiled with an enable-fast switch. All tests were compiled with gcc (version 2.95.3) -O3 switch. The Solaris cluster consisted of 25 Sun Blade500 processors connected in groups of five 100 Mbps switches interconnected via a half-duplex 10 Mbps switch. All processors have exactly the same configuration. The tests were run on processors connected on the same 100 Mbps switch. The Synergy and PML experiments were tested with worker fault tolerance turned on. MPICH has no fault tolerance features. The subscripts in all programs are optimized to maximize locality in their memory access patterns.

As shown in FIG. 6, Synergy programs were manually created and ran with tuned granularity G. A MPICH program was also manually created. Its granularity is fixed: N/P. The program terminates if N is not multiple of P. Recorded times were the best of four consecutive runs.

The new stateless parallel processing system (SPPM) can inherit all generic properties of a dataflow machine. Different from past dataflow parallel machines, a coarse-to-fine processing granularity exploitation is emphasized in order to gain cost-effective performance. A blueprint of SPPM and its prototype implementation using commodity processors has been disclosed. A parallel markup language (PML) design has also been disclosed for automatic generation of cost-efficient data parallel code from sequential programs. The preliminary results indicate that application fault tolerance, high performance and programming ease can be all gained, if the implicit parallel processing model is adapted to.

Comparing SPPM with all other existing parallel processors, SPPM is the first to arm itself with an enhanced layer of communication designed to deliver high performance and high availability at the same time. The concept of UVR can be implemented using commodity components, PFGA or custom ASICs. For all existing HPC applications using explicit parallelisms, tools can be developed to automatically translate them to use the implicit model.

Incidentally, the application of SPPM principles has also already achieved surprising results in transaction processing systems. For database clusters, an enhanced communication layer capable of parallel synchronous transaction replication can indeed deliver higher performance and higher availability at the same time.

It is interesting to note that contrary to what many have believed, for HPC, the most desirable communication mode is asynchronous. For high performance transaction systems, the most desirable solution is parallel synchronous replication (spatial redundancy). Finally, parallelism must be sought in a coarse-to-fine progression.

The dataflow parallel processing model fits SPP requirement perfectly since each computing unit is activated only by its required data. There are no extra dependencies or control flows. Since dataflow parallel processing model uses implicit higher-level parallelism, programming is easier than explicit parallel programming methods, such as MPI, it is then possible to construct an XML-based markup language and compiler to generate data-parallel programs directly from sequential source codes using high-level data partitioning directives. The significance of this compiler is that it enables exploiting the optimal processing granularity by changing program partitioning depth and processing granularity. Finding the optimal processing granularity is practically impossible using explicit parallel programming methods due to programming complexities.

For availability, the dataflow parallel processing model allows cheap temporal redundancy by shadowing working assignments for stateless workers. A simple CPR implementation can support multiple dependent master fault tolerance and recovery. The overheads of these fault tolerance measures are practically negligible during normal execution. Preliminary studies have shown that the SPP system can indeed deliver competitive performance (against MPI counter parts) and high availability at the same time.

Although the features and elements of the present invention are described in the preferred embodiments in particular combinations, each feature or element can be used alone or in various combinations with or without other features.

What is claimed is:

1. A fault-tolerant self-optimizing multi-processor system comprising:
a plurality of redundant network switching units; and
a plurality of processors electrically coupled to the redundant network switching units, each processor comprising a routing agent (RA), wherein the RAs form a unidirectional virtual ring (UVR) network.

2. The system of claim 1 wherein each of the processors further comprises:
a local memory;
a local storage; and
multiple network interfaces.

3. The system of claim 1 wherein the UVR network coordinates all of the processors for data matching, failure detection/recovery and system management functions.

4. The system of claim 1 wherein each of the RAs implement a tuple space daemon responsible for data matching and delivery, forwarding unsatisfied data requests to a downstream processor or dropping expired tuples from UVR circulation.

5. The system of claim 1 wherein each of the RAs provide application management such that one or more local processes may be executed, monitored, killed or suspended upon request.

6. The system of claim 1 wherein each of the RAs provide UVR management by monitoring, repairing, reconfiguring, stopping and starting the UVR network.

7. The system of claim 1 wherein each of the RAs provide fault tolerance, wherein the RA runs a self-healing protocol by maintaining a “live downstream processor” contact.

8. The system of claim 1 wherein a UVR broadcast protocol is implemented in parallel using a ring-hopping algorithm.

9. The system of claim 1 wherein the network switching units form a physical redundant point-to-point network.

10. The system of claim 1 wherein the UVR network facilitates massive parallel dataflow communication for tuple matching.

11. A stateless parallel processing (SPP) system comprising:
a unidirectional virtual ring (UVR) network;
a plurality of processors, wherein each of the processors includes a routing agent (RA) that contributes to forming the UVR network; and
a physical redundant point-to-point network in communication with the processors, wherein the UVR network is configured to leverage multiple network interfaces on each processor such that all processors may selectively communicate with any other processors in parallel.

12. The system of claim 11 wherein each of the processors further comprises:
a local memory;
a local storage; and
multiple network interfaces.

13. The system of claim 11 wherein the UVR network coordinates all of the processors for data matching, failure detection/recovery and system management functions.

14. The system of claim 11 wherein each of the RAs implement a tuple space daemon responsible for data matching and delivery, forwarding unsatisfied data requests to a downstream processor or dropping expired tuples from UVR circulation.

15. The system of claim 11 wherein each of the RAs provide application management such that one or more local processes may be executed, monitored, killed or suspended upon request.

16. The system of claim 11 wherein each of the RAs provide UVR management by monitoring, repairing, reconfiguring, stopping and starting the UVR network.

17. The system of claim 11 wherein each of the RAs provide fault tolerance, wherein the RA runs a self-healing protocol by maintaining a “live downstream processor” contact.

18. The system of claim 11 wherein a UVR broadcast protocol is implemented in parallel using a ring-hopping algorithm.

19. The system of claim 11 wherein the UVR network facilitates massive parallel dataflow communication for tuple matching.

20. A method of processing data using a stateless parallel processing (SPP) system including a plurality of processors, the method comprising:
selectively connecting a plurality of processors to each other via a switching fabric, each of the processors including a routing agent (RA); and
using the RAs to form a unidirectional virtual ring (UVR) network, wherein the UVR network coordinates all of the processors for data matching, failure detection/recovery and system management functions.

21. The method of claim 20 further comprising:
each of the RAs implementing a tuple space daemon responsible for data matching and delivery, forwarding unsatisfied data requests to a downstream processor or dropping expired tuples from UVR circulation.

22. The method of claim 20 further comprising:
each of the RAs providing application management such that one or more local processes may be executed, monitored, killed or suspended upon request.

23. The method of claim 20 further comprising:
each of the RAs providing UVR management by monitoring, repairing, reconfiguring, stopping and starting the UVR network.

24. The method of claim 20 further comprising:
each of the RAs providing fault tolerance, wherein the RA runs a self-healing protocol by maintaining a “live downstream processor” contact.

25. The method of claim 20 further comprising:
implementing a UVR broadcast protocol in parallel using a ring-hopping algorithm.
